(19) United States
(12) Patent Application Publication
(10) Pub. No.: US 2016/0063786 A1
(43) Pub. Date: Mar. 3, 2016

(54) SMARTPHONE ENABLED PASSIVE ENTRY GO SYSTEM

(71) Applicants: Hyundai America Technical Center, Inc., Superior Township, MI (US); Hyundai Motor Company, Seoul (KR); Kia Motors Corporation, Seoul (KR)

(72) Inventors: Allan Lewis, Windsor (CA); Mark S. Topping, Lincoln Park, MI (US); Bilal Javaid, Ada, MI (US)

(21) Appl. No.: 14/468,924

(22) Filed: Aug. 26, 2014

(51) Int. Cl. G07C 9/00

(52) U.S. Cl. CPC G07C 9/00896; G07C 9/00309

(57) ABSTRACT

In one embodiment, a method is disclosed in which the signal strength of a wireless connection is evaluated to determine a proximity of a portable electronic device relative to a vehicle. Based on the determined proximity of the portable electronic device, one or more doors of the vehicle are unlocked. A push button ignition of the vehicle is also enabled based on a determination that the portable electronic device is located within the vehicle.

### BACKGROUND

(a) Technical Field

The present disclosure generally relates to a vehicle access system. In particular, a passive vehicle access system is disclosed in which access to the vehicle is enabled based on the proximity of a portable electronic device.

(b) Background Art

Traditional vehicle access systems are fully manual and use mechanical mechanisms to secure a vehicle. For example, a user may first insert a physical key into a door lock of the vehicle to unlock the door and enter the vehicle. Next, the user may insert the key into an ignition, to start the vehicle. While generally functional, such systems suffer from requiring users to perform a number of manual steps before being able enter and start a vehicle. In addition, these systems require a user to carry the physical key on his or her person. Thus, if the user does not have the key in his or her possession, he or she will be unable to unlock or start the vehicle. For example, the user may be locked out of the vehicle if he or she accidentally locks the key in the vehicle.

Some attempts have been made to integrate electronic mechanisms into vehicle access systems. In some cases, a vehicle may be equipped with an electronic keypad in addition to a manual door lock, allowing a user to enter the vehicle without a physical key. In these systems, a user can still access the vehicle by operating the keypad, if the user locks his or her keys in the vehicle. Other systems have attempted to integrate wireless technologies into the key fob of a physical key. For example, some vehicle keys are now equipped with buttons that allow a user to remotely lock or unlock the doors of a vehicle. While these types of systems are slightly more convenient for a user, they still require the user to carry and manipulate a separate piece of equipment.

In order to solve the problems in the related art, there is a demand for a passive vehicle access system that enables access to a vehicle without any, or extremely limited, action by the user.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides systems and methods for providing passive access to a vehicle. In particular, the proximity of an authorized portable electronic device to the vehicle may be used to lock or unlock the doors of the vehicle and/or to enable the ignition of the vehicle.

In one embodiment, a method is disclosed in which a signal strength of a wireless connection is evaluated to determine a proximity of a portable electronic device relative to a vehicle. Based on the determined proximity of the portable electronic device relative to the vehicle, one or more doors of the vehicle are unlocked. A push button ignition of the vehicle is also enabled based on a determination that the portable electronic device is located within the vehicle.

According to various aspects, the method may also include receiving a request for a slower connection from the portable electronic device and changing connection parameters used to communicate with the portable electronic device. In one aspect, the method may include advertising an identity of the vehicle to the portable electronic device. In another aspect, the location of the portable electronic device may be determined using a detected path loss. In a further aspect, the method may include receiving a temporary authorization code from a wireless network, entering a pairing mode with the portable electronic device, receiving an authorization code from the portable electronic device, and paring the vehicle to the portable electronic device by comparing the authorization code from the wireless network to the authorization code from the portable electronic device. In some cases, a generated passcode may be provided to an electronic display of the vehicle. In further cases, an encrypted connection may be established with the portable electronic device.

In another embodiment, a method is disclosed that includes modifying an online account to authorize passive remote control of a vehicle. The method also includes receiving, at a portable electronic device, an authorization code generated by the online account. The method further includes establishing, by the portable electronic device, a connection with the vehicle. The method additionally includes providing the authorization code to the vehicle to pair the portable electronic device to the vehicle. The method yet further includes storing identity data regarding the paired vehicle.

According to various aspects, identification data advertised by the vehicle may be received and compared to the stored identity data. In another aspect, encryption information may be exchanged with the vehicle. In a further aspect, a battery charge of the portable electronic device may be determined to be below a threshold charge and, in response, applications executed by the portable electronic device may be closed automatically to conserve battery charge.

In yet another embodiment, an apparatus is disclosed. The apparatus includes one or more interfaces configured to communicate wirelessly with a portable electronic device and via the Internet. The apparatus also includes a processor configured to execute one or more processes and a memory configured to store a process executable by the processor. When executed by the processor, the process is operable to evaluate a signal strength a wireless connection to determine a proximity of a portable electronic device relative to a vehicle. The process when executed is also operable to cause one or more doors of the vehicle to unlock based on the determined proximity of the portable electronic device relative to the vehicle. The process when executed is further operable to enable a push button ignition of the vehicle based on a determination that the portable electronic device is located within the vehicle.

According to various aspects, the interface may be configured to wirelessly communicate with the portable electronic device has a peak current consumption that is less than fifteen miliamperes (15 mA). In another aspect, the apparatus may include an antenna mounted on a driver's side mirror that receives the connection request from the portable electronic device. In a further aspect, the one or more doors that are unlocked may be selected based on a user preference parameter.

Advantageously, the systems and methods described herein allow a vehicle to be accessed passively and without further action by a user. In particular, once a user's portable electronic device has been paired to the vehicle, access to the vehicle may be enabled or disabled based on the proximity of the device to the vehicle.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is an example illustration of a passive vehicle access system;

FIG. 2 is an example circuit diagram of a wireless transceiver;

FIG. 3 is an example circuit diagram of a vehicle interface module;

FIG. 4 is an example simplified procedure for pairing a portable electronic device to a vehicle; and

FIG. 5 is an example simplified procedure for operating a passive vehicle access system.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present disclosure will be described so as to be easily embodied by those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that some of the methods may be executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention provides a passive vehicle access system that enables and disables entry to the vehicle based on the proximity of an authorized portable electronic device to the vehicle. The ignition of the vehicle may also be enabled or disabled based on whether the portable electronic device is located within the vehicle itself. Further, the techniques herein are passive in that a user is not required to do anything other than have the portable electronic device on his or her person.

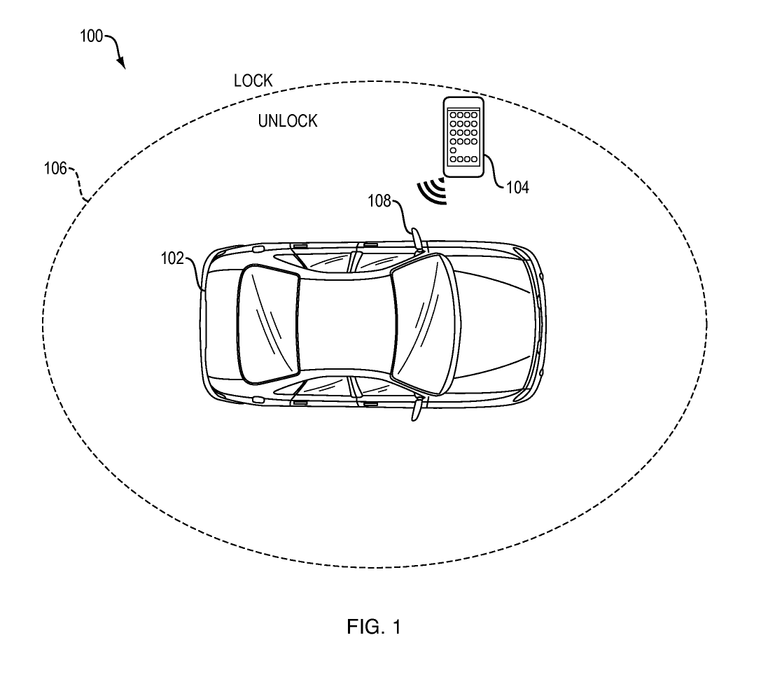

Referring now to FIG. 1, a passive vehicle access system 100 is shown, according to various embodiments. In general, vehicle access system 100 includes a vehicle 102 and a portable electronic device 104 that communicate wirelessly with one another. Portable electronic device 104 may be any form of electronic device that is configured and intended for mobile operation. For example, portable electronic device 104 may include a cordless power system, such as a battery system or solar cell that enables portable operation. Example forms of portable electronic devices include, but are not limited to, cellular phones, tablet devices, smart watches, optical head mounted displays (OHMDs), and the like.

Each of vehicle 102 and portable electronic device 104 may be configured to communicate with wireless access points, thereby enabling vehicle 102 and portable electronic device 104 to communicate via the Internet. Such access points may include, for example, WiFi hotspots, cellular providers, satellite communication systems, or the like.

In some embodiments, vehicle 102 and portable electronic device 104 are also configured to communicate using a short range wireless connection. For example, vehicle 102 and portable electronic device 104 may communicate using a wireless protocol that has a range of fifty meters or less. In one embodiment, portable electronic device 104 and vehicle 102 must first be paired before substantive communication can begin between the two. To facilitate the nearby communication with a portable electronic device, vehicle 102 may be equipped with one or more antennas. For example, an antenna may be integrated into the driver's side mirror 108 of vehicle 102.

During operation, vehicle 102 may perform various actions based on the proximity and/or direction of travel of portable device 104 relative to vehicle 102. In one embodiment, the estimated proximity of portable electronic device 104 relative to vehicle 102 may be determined by vehicle 102 and/or by portable electronic device 104 based on the wireless communication signals sent between portable electronic device 104 and vehicle 102. For example, the proximity of portable electronic device 104 to vehicle 102 may be calculated using a simplified path loss model as follows:

$${P}_{r} = {P}_{t} {K [ \frac{{d}_{0}}{d} ]}^{γ}$$

where Pᵣ is the power of the received signal, Pₜ is the power of the transmitted signal, d is the distance between vehicle 102 and portable electronic device 104, d₀ is a reference distance, K is a constant factor (Pᵣ(d₀)/Pₜ), and γ is the path loss exponent. In some cases, the amount of path loss may be calculated by subtracting the received signal strength (RSSI) of the vehicle from the transmission power of portable electronic device 104. In another embodiment, the actual location of portable electronic device 104 may be determined. Similarly, a direction of movement of portable electronic device 104 relative to vehicle 102 may be determined based on a change in the signal strength or path loss. For example, if the amount of path loss is decreasing, it may be determined that portable electronic device 104 is moving towards vehicle 102.

Vehicle 102 and/or portable electronic device 104 may compare the distance between the two to a threshold distance value and initiate vehicle access operations based on the comparison. In one embodiment, vehicle 102 calculates the range to portable electronic device 104 and, in response, initiates a vehicle access operation. In another embodiment, portable electronic device 104 calculates the range to vehicle 102 and, in response, sends a command to vehicle 102 to initiate the operation. In one example, if the distance to portable electronic device 104 is below a proximity threshold 106, vehicle 102 may unlock one or more doors of vehicle 102. Conversely, if the distance to portable electronic device 104 is greater than proximity threshold 106, vehicle 102 may lock the doors of vehicle 102. In some cases, the particular door or doors that are locked or unlocked may be controlled by a user setting. In one embodiment, a second proximity threshold may be used to determine whether or not portable electronic device 104 is located within vehicle 102. If so, vehicle 102 may enable the ignition of vehicle 102. For example, vehicle 102 may enable a push-button style ignition, if portable electronic device 104 is located within vehicle 102. In further operations, vehicle 102 may perform user-specific operations based on the identity of portable electronic device 104. For example, vehicle 102 may adjust a seat setting, radio presets, climate controls, or other user settings based on the identity of portable electronic device 104. In one embodiment, vehicle 102 may use a debounce algorithm to prevent rapid, unintended fluctuations in the operation of the vehicle (e.g., switching between locking an unlocking the doors, etc.).

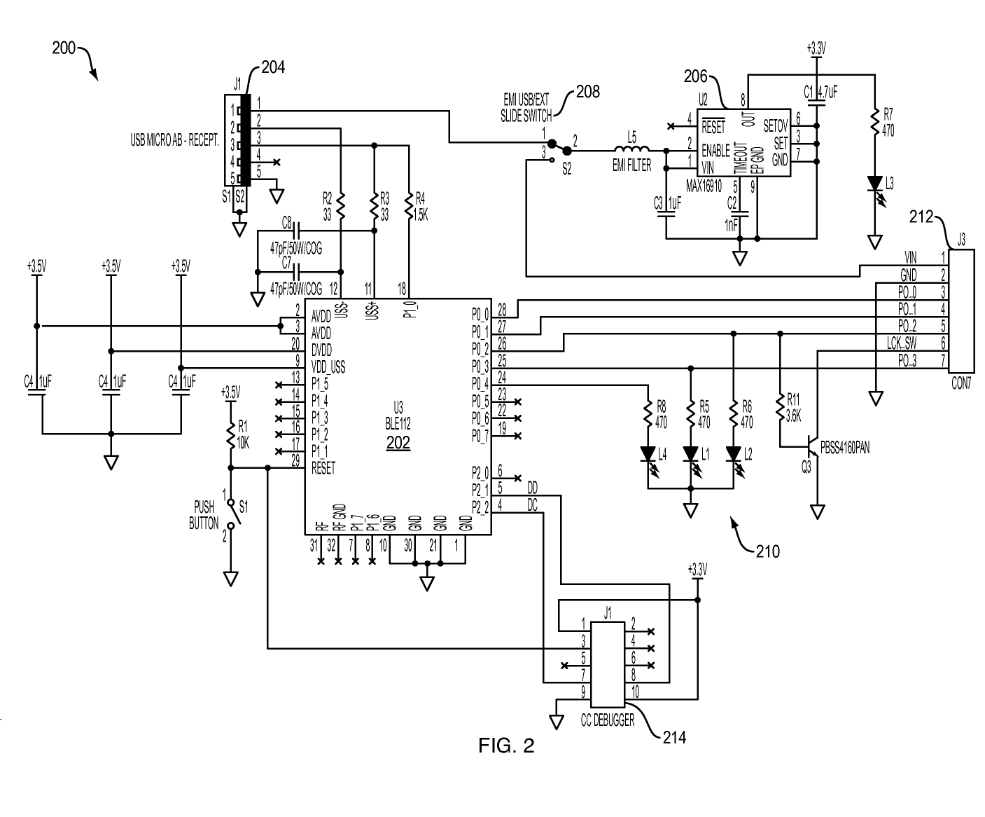

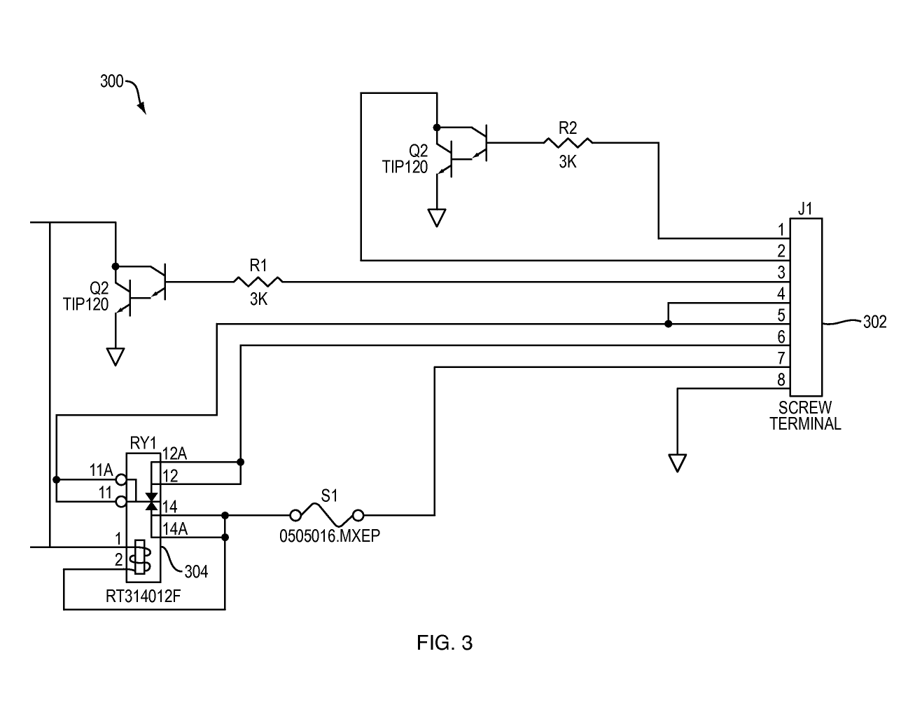

Proof of concept hardware diagrams are shown in FIGS. 2-3. In FIG. 2, an example circuit diagram of a wireless transceiver 200 is shown, according to various embodiments. As shown, transceiver 200 is configured to use the Bluetooth™ Low Energy protocol, although other wireless protocols may be used in other embodiments. In comparison to traditional Bluetooth™ communications, Bluetooth™ Low Energy sacrifices transmission range (e.g., a maximum range of 100 m vs. 50 m) for considerably lower latency (e.g., ˜100 ms vs. 6 ms) and current draw (e.g., less than 30 mA vs. less than 15 mA). The use of a wireless protocol having a low current draw and power consumption is preferred herein to minimize the draw on the battery of the vehicle or portable electronic device.

At the core of transceiver 200 is an integrated circuit 202 which may implement the nearby wireless protocol used by transceiver 200. Integrated circuit 202 includes a central processing unit (CPU), integrated memory coupled to the CPU (e.g., a volatile memory, a non-volatile program memory, etc.), and various interfaces such as pin-ins and pin-outs configured to receive or transmit signals to other electronics in transceiver 200. In one embodiment, integrated circuit 202 also includes an integrated antenna, allowing integrated circuit 202 to receive and transmit data wirelessly using the implemented wireless protocol. Other devices coupled to integrated circuit 202 may include a universal serial bus (USB) port 204 or other data port, a linear regulator 206, a debugger interface 214 (e.g., to allow different input conditions to be tested), a wire harness terminal 212, light emitting diode (LED) indicators 210, or the like.

In some embodiments, integrated circuit 202 is programmed to perform various vehicle access operations based on the proximity of a portable electronic device to the vehicle. For example, pseudocode for the unlock operation on the vehicle is as follows:

# client wrote to local GATT database
event attributes_value(cnnx, reason, handle, offset, val_len, value)
# check if client is trying to change the lock state

if handle = xgatt_lock_state_cntrl then

# change lock state as long as not rapid switching, otherwise
ignore
if (transient time >= TRANS_WAIT) then

lockState = value(0:1)

endif
# send signal to vehicle controller
@updateDisplayAndSendSignal

end if

end

In the above code, the door unlock command is sent only if the last time the door was locked exceeds a threshold amount of time (e.g., to prevent rapid switching between lock states). As will be appreciated, any suitable programming language may be used to program integrated circuit 202, such as BGScript.

In some implementations, the portable electronic device performs corresponding vehicle access routines by executing an application (e.g., a mobile “app”) within the device's operating system. For example, pseudocode for the unlock routine of such an application is shown below:

// check where portable device is, send unlock / lock command if
necessary
debounceCntrs[0] = debounceCntrs[0] + 1;
if (debouncCntrs[0] >= 2)

{ //phone has been reported in unlock zone two consecutive times

[self sendUnlockCmd];
debounceCntrs[0] = 0;

}

// reset lock counter
debounceCntrs[1] = 0;

As shown above, the application running on the portable device may determine the proximity of the device in relation to the vehicle and, in response, determine whether or not to send an unlock command to the vehicle. Such an application may be programmed in any suitable language, such as objective-C or the like. In some embodiments, the application running on the portable device is also configured to monitor the available battery charge of the device and, if the charge is below a threshold value, take power saving measures such as closing out other applications. Thus, if the user's device is low on charge, he or she may still access the vehicle.

FIG. 3 illustrates an example interface board 300 for a vehicle, according to various embodiments. Interface board 300 generally includes a screw terminal 302 that allows, for example, the relatively low power command signals from transceiver 200 to be provided to higher power devices of the vehicle via relay 304.

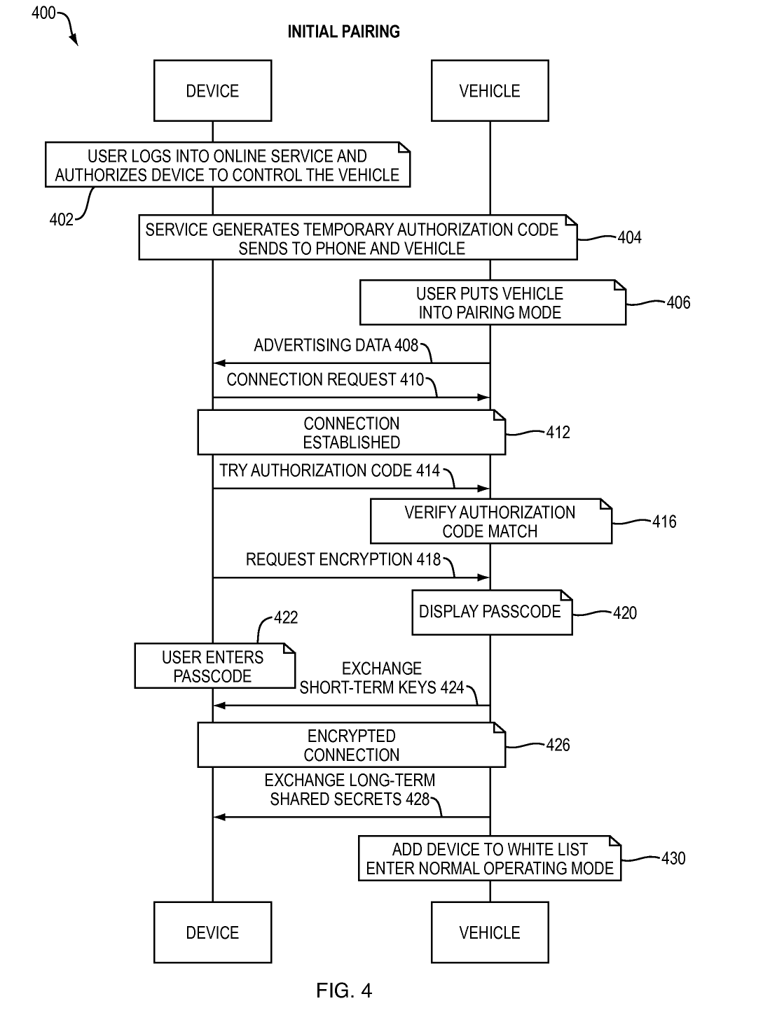

Referring now to FIG. 4, an example simplified procedure 400 for pairing a portable electronic device to a vehicle is shown, according to various embodiments. For example, procedure 400 may be performed by portable electronic device 104 and vehicle 102 shown in FIG. 1. In general, procedure 400 allows the portable device to be authorized to cause the vehicle to perform vehicle access operations via an initial pairing.

At step 402, the user logs into an online service and authorizes the device to control the vehicle. For example, the manufacturer of the vehicle may allow users to create online accounts that store user preferences used by the vehicle access system (e.g., which devices are authorized to access the vehicle, which user-specific operations are performed by the vehicle, etc.). As will be appreciated, step 402 may be performed using the portable device, the vehicle, or any other computing device that has access to the Internet (e.g., a home computer, a work computer, etc.). When performed at the portable device, a unique device identifier may be sent with the authorization request and associated with the user's account (e.g., to uniquely identify the user's device). In cases in which the authorization is performed on another computing device, the user may be asked to provide certain information to uniquely identify his or her device to the service.

At step 404, a temporary authorization code is sent by the online service to both the portable device and the vehicle via their respective Internet connections (e.g., via a WiFi connection, cellular network, etc.). This authorization code may be used by the vehicle to ensure that the mobile device requesting to be paired with the vehicle is authorized to do so.

At some point in time after the user authorizes the portable device to control access to the vehicle through the online account, a wireless connection may be established between the portable device and the vehicle. At step 406, the vehicle may be placed into a pairing mode by the user. For example, the user may request that the vehicle pair and authorize his or her portable device by operating a touch screen display of the vehicle. At step 408, in response to entering a paring mode, the vehicle then advertises pairing information to the portable device. The advertised information may include, for example, the identity of the device or other such information that prompts a response from the portable electronic device to being communicating with the vehicle. At step 410, the portable electronic device then sends a connection request to the vehicle and, at step 412, a wireless connection between the vehicle and the portable device is established. In various embodiments, the connection may be in accordance with the Bluetooth™ Low Energy protocol.

Once a wireless connection has been established between the portable device and the vehicle, an authorization check is then made. At step 414, once a wireless connection has been established with the vehicle, the portable device sends its temporary authorization code to the vehicle. At step 416, the vehicle then compares the authorization code received from the portable device to the authorization code that it received via the Internet from the online service. If the two codes match, the vehicle is ensured that the portable device is the same device that the user authorized and procedure 400 continues. Otherwise, the vehicle may terminate further processing of procedure 400.

In some embodiments, an encrypted connection may be established between the portable device and the vehicle. At step 418, for example, the portable device may request encryption from the vehicle. At step 420, the vehicle then displays a passcode to the user via an electronic display of the vehicle (e.g., an in-dash touch screen display). At step 422, the user then enters the passcode into his or her portable device. At step 424, short-term encryption keys are then exchanged between the vehicle and the portable device and an encrypted connection is established at step 426. Once an encrypted connection has been established, long-term shared secrets are shared between the vehicle and the portable device at step 428, to ensure that future connections between the two are similarly encrypted.

After exchanging the information necessary to establish future connections between the portable device and the vehicle, information may be saved at either or both devices to facilitate future connections. At step 430, for example, the vehicle may add the identity of the portable device to a stored white list and re-enter a normal operating mode. In another example, the portable device stores the identity of the vehicle with the encryption data, to identify and re-establish a connection with the vehicle at a later date. In one embodiment, any number of portable devices may also be authorized to provide access to the vehicle by repeating procedure 400.

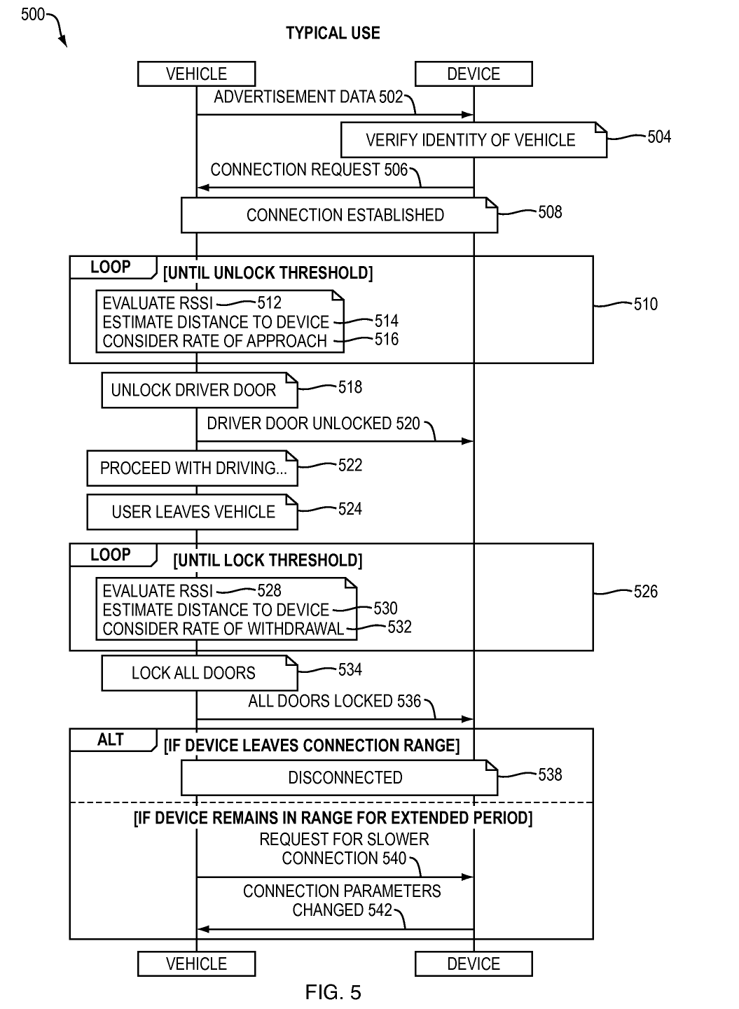

Referring now to FIG. 5, an example simplified procedure 500 for operating a passive vehicle access system is shown, according to various embodiments. Similar to procedure 400, procedure 500 may be performed by a portable device (e.g., portable device 104) in communication with a vehicle (e.g., vehicle 102). In some embodiments, procedure 500 may be performed after procedure 400 (e.g., after the portable device has been authorized and paired to the vehicle).

Procedure 500 begins by establishing a wireless connection between the vehicle and the portable device. At step 502, the vehicle advertises connection data. For example, the vehicle may advertise information regarding its identity and other such information that may be used by a portable device to determine whether or not to establish a connection with the vehicle. At step 504, the advertised identity of the vehicle is verified by the portable electronic device (e.g., by comparing the identity of the vehicle to that stored as a result of pairing procedure 400). If the identity of the vehicle matches that stored previously by the device, the portable device then send a connection request to the vehicle, as shown in step 506. In one embodiment, the connection request includes information used by the vehicle to establish an encrypted connection. In response to receiving the connection request, a wireless connection is then established between the vehicle and the portable device.

Once a connection has been established between the vehicle and the portable device, any number of checks may be performed to evaluate whether or not a vehicle access operation is to be performed. As shown, a processing loop 510 may be repeated any number of times upon initially establishing a connection between the vehicle and the portable device. As part of loop 510, the RSSI of the connection is evaluated at step 512 and used to estimate the distance between the vehicle and the mobile device. In some embodiments, loop 510 also includes step 516 where a rate of approach is determined based on a change in the RSSI data.

Loop 510 may be repeated any number of times until the distance calculated in step 514 is below a threshold value and the portable device is approaching the vehicle. In such a case, one or more doors of the vehicle are unlocked, as shown in step 518. In one embodiment, a notification is sent from the vehicle to the portable device indicating that the doors are now unlocked, as shown in step 520. Optionally, a further check may be performed in a similar manner to enable the ignition of the vehicle after verifying that the portable device is now located within the vehicle or within a very close proximity of the vehicle.

A door lock operation may also occur at a later point in time, as shown in FIG. 5. For example, at step 522, the driver may proceed with driving the vehicle for any amount of time and, at step 524, exit the vehicle. In one embodiment, a loop 526 is performed any number of times to initiate a door lock operation. Loop 526 includes step 528 where an RSSI of the connection between the vehicle and the portable device is evaluated. Based on the evaluation, a distance between the vehicle and the device is estimated, as shown in step 530. In some cases, a rate of withdrawal may also be determined based on the change in the signal strength, as shown in step 532. If the distance between the vehicle and portable device exceeds a threshold distance, and the portable device is moving away from the vehicle, the doors of the vehicle may be locked automatically, as shown in step 534. In various embodiments, the lock and unlock distance thresholds may or may not be the same. For example, the lock threshold may be greater than the unlock threshold to prevent the user from being locked out while pumping gas. At step 536, a notification may be sent to the portable device that all doors of the vehicle have been locked.

Various other operations may also be performed as part of procedure 500. For example, if the portable device is completely outside of the connection range, the vehicle may terminate the connection at step 538. In one embodiment, if the device and vehicle remain in contact for a threshold amount of time, a slower connection may be used to conserve power. For example, as shown in step 540, the vehicle may request a slower connection with the portable device and, as shown in step 542, the portable device may notify the vehicle that the connection parameters have been changed to lower the connection speed.

It should be noted that while certain steps within procedures 400-500 may be optional as described above, the steps shown in FIGS. 4-5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 400-500 are described separately, certain steps from each procedure may be incorporated into each other procedure, and the procedures are not meant to be mutually exclusive.

Advantageously, the techniques described herein provide for a passive vehicle access system that allows vehicle access to be controlled based on the proximity of an authorized portable device to the vehicle. Thus, in some implementations, a user may not even need to carry a physical key for the vehicle on his or her person. In other implementations, the system may still support the use of a physical key, allowing a user to choose which access mechanism is used. Once the portable device is authorized and paired to the vehicle, no further action is required of the user to unlock/lock the doors of the vehicle or to enable the vehicle's ignition so long as the user has his or her portable device.

While the embodiment of the present disclosure has been described in detail, the scope of the right of the present disclosure is not limited to the above-described embodiment, and various modifications and improved forms by those skilled in the art who use the basic concept of the present disclosure defined in the appended claims also belong to the scope of the right of the present disclosure.

What is claimed is:

1. A method comprising:
evaluating a signal strength of a wireless connection to determine a proximity of a portable electronic device relative to a vehicle;
causing one or more doors of the vehicle to unlock based on the determined proximity of the portable electronic device relative to the vehicle; and
enabling a push button ignition of the vehicle based on a determination that the portable electronic device is located within the vehicle.

2. The method as in claim 1, further comprising:
causing the one or more doors of the vehicle to lock based on a determination that the portable electronic device is moving away from the vehicle.

3. The method as in claim 1, further comprising:
receiving a request for a slower connection from the portable electronic device; and
changing connection parameters used to communicate with the portable electronic device.

4. The method as in claim 1, further comprising:
advertising an identity of the vehicle to the portable electronic device.

5. The method as in claim 1, wherein the location of the portable electronic device is determined using a detected path loss.

6. The method as in claim 1, further comprising:
receiving a temporary authorization code from a wireless network;
entering a pairing mode with the portable electronic device;
receiving an authorization code from the portable electronic device; and
paring the vehicle to the portable electronic device by comparing the authorization code from the wireless network to the authorization code from the portable electronic device.

7. The method as in claim 6, further comprising:
providing a generated passcode to an electronic display of the vehicle.

8. The method as in claim 6, further comprising:
establishing an encrypted connection with the portable electronic device.

9. A method comprising:
modifying an online account to authorize passive remote control of a vehicle;
receiving, at a portable electronic device, an authorization code generated by the online account;
establishing, by the portable electronic device, a connection with the vehicle;
providing the authorization code to the vehicle to pair the portable electronic device to the vehicle; and
storing identity data regarding the paired vehicle.

10. The method as in claim 9, further comprising:
receiving identification data advertised by the vehicle; and
comparing the identification data to the stored identity data.

11. The method as in claim 10, further comprising:
exchanging encryption information with the vehicle.

12. The method as in claim 9, further comprising:
determining that a battery charge of the portable electronic device is below a threshold charge and, in response,
closing applications executed by the portable electronic device to conserve battery charge.

12. An apparatus comprising:
one or more interfaces configured to communicate wirelessly with a portable electronic device and via the Internet;
a processor configured to execute one or more processes; and
a memory configured to store a process executable by the processor, the process when executed operable to:
evaluate a signal strength of a wireless connection to determine proximity of a portable electronic device relative to a vehicle;
cause one or more doors of the vehicle to unlock based on the determined proximity of the portable electronic device relative to the vehicle; and
enable a push button ignition of the vehicle based on a determination that the portable electronic device is located within the vehicle.

13. The apparatus as in claim 12, wherein the process when executed is operable to:
cause the one or more doors of the vehicle to lock based on a determination that the portable electronic device is moving away from the vehicle.

14. The apparatus as in claim 12, wherein the process when executed is operable to:
receive a request for a slower connection from the portable electronic device; and
change connection parameters used to communicate with the portable electronic device.

15. The apparatus as in claim 12, wherein the process when executed is operable to:
receive a temporary authorization code from a wireless network;
enter a pairing mode with the portable electronic device;
receive an authorization code from the portable electronic device; and
pair the vehicle to the portable electronic device by comparing the authorization code from the wireless network to the authorization code from the portable electronic device.

16. The apparatus as in claim 15, wherein the process when executed is operable to: provide a generated passcode to an electronic display of the vehicle.

17. The apparatus as in claim 12, wherein the process when executed is operable to:
establish an encrypted connection with the portable electronic device.

18. The apparatus as in claim 12, wherein the interface configured to wirelessly communicate with the portable electronic device has a peak current consumption that is less than fifteen miliamperes (15 mA).

19. The apparatus as in claim 12, further comprising:
an antenna mounted on a driver's side mirror that receives the connection request from the portable electronic device.

20. The apparatus as in claim 12, wherein the one or more doors that are unlocked are selected based on a user preference parameter.
